(19) United States
(12) Patent Application Publication
(10) Pub. No.: US 2025/0386129 A1
(43) Pub. Date: Dec. 18, 2025

(54) WEARABLE ELECTRONIC DEVICE

(71) Applicant: SAMSUNG ELECTRONICS CO., LTD., Suwon-si (KR)

(72) Inventors: Yeongjun KIM, Suwon-si (KR); Jeock LEE, Suwon-si (KR); Hunki Lee, Suwon-si (KR); Janghoon KANG, Suwon-si (KR); Seonmi KIM, Suwon-si (KR); Yonghoon LEE, Suwon-si (KR); Hochul HWANG, Suwon-si (KR)

(73) Assignee: SAMSUNG ELECTRONICS CO., LTD., Suwon-si (KR)

(21) Appl. No.: 19/173,078

(22) Filed: Apr. 8, 2025

Related U.S. Application Data
(63) Continuation of application No. PCT/KR2025/003856, filed on Mar. 26, 2025.

(30) Foreign Application Priority Data
Jun. 18, 2024 (KR) 10-2024-0079224
Jul. 9, 2024 (KR) 10-2024-0090259

(51) Int. Cl. H04R 1/10

(52) U.S. Cl. CPC H04R 1/1075; H04R 1/1016; H04R 1/1025; H04R 2460/11

(57) ABSTRACT

A wearable electronic device includes: a housing including a first opening and a second opening; a bracket disposed in an inner space of the housing and including a side portion facing the second opening; and a plate disposed between the housing and the side portion of the bracket. The side portion of the bracket includes a recess being recessed inward from an outer surface of the side portion and extending toward the first opening from an area overlapping the second opening. The plate is seated on the side portion and covers at least a portion of the recess. A duct is formed by the recess and is between the side portion of the bracket and the plate, and is configured to communicate with the inner space. The plate includes a plate hole configured to allow the duct to communicate with the second opening.

### CROSS-REFERENCE TO RELATED APPLICATIONS

This application is a continuation application, claiming priority under § 365(c), of an International application No. PCT/KR2025/003856, filed on Mar. 26, 2025, which is based on and claims the benefit of a Korean patent application number 10-2024-0079224, filed on Jun. 18, 2024, in the Korean Intellectual Property Office, and of a Korean patent application number 10-2024-0090259, filed on Jul. 9, 2024, in the Korean Intellectual Property Office, the disclosure of each of which is incorporated by reference herein in its entirety.

### BACKGROUND

The disclosure relates to a wearable electronic device and having an improved acoustic duct.

With the advancement of electronic technology, various types of wearable electronic devices are becoming more compact and equipped with diverse functionalities.

Components associated with at least one sound effect may be disposed on a printed circuit board of a wearable electronic device. The components associated with sound effects may include, for example, a speaker and a microphone. These components may be arranged inside a housing of the wearable electronic device in various shapes and arrangements to correspond to various exterior designs of the wearable electronic device.

The wearable electronic device including a speaker and a microphone may correspond to an in-ear earphone (or ear set, headphone, or headset), or a hearing aid. The wearable electronic device may be worn close to the user's ears, and to this end, the wearable electronic device may be manufactured in a compact size.

### SUMMARY

According to an aspect of the present disclosure, a wearable electronic device includes: a housing including a first opening and a second opening; a bracket disposed in an inner space of the housing and including a side portion facing the second opening; and a plate disposed between the housing and the side portion of the bracket. The side portion of the bracket includes a recess being recessed inward from an outer surface of the side portion and extending toward the first opening from an area overlapping the second opening. The plate is seated on the side portion and covers at least a portion of the recess. A duct is formed by the recess and is between the side portion of the bracket and the plate, and is configured to communicate with the inner space. The plate includes a plate hole configured to allow the duct to communicate with the second opening.

The wearable electronic device may further include a first adhesive member between the side portion and the plate, and the first adhesive member may be configured to attach the plate to the side portion.

The first adhesive member may include an adhesive opening having a shape corresponding to a shape of the recess.

The duct may be defined by the recess, the plate, and the first adhesive member.

The first adhesive member may be provided with at least one of double-sided tape, bond, glue or adhesive.

A length between a point of the duct, corresponding to a central part of the plate hole, and a side end of the duct corresponding to the first opening may be 4 mm or less.

The wearable electronic device may further include a mesh member disposed outside the plate and configured to cover the plate hole.

The wearable electronic device may further include a waterproof member disposed outside the plate and configured to cover the plate hole.

The wearable electronic device may further include a compression member disposed outside the plate.

The plate may include at least one of steel use stainless (SUS), steel plate cold rolled commercial (SPCC), or polycarbonate (PC) of polyethyleneterephthalate (PET).

The plate hole may extend in a direction intersecting a direction in which the duct extends.

The bracket may further include a seating portion disposed on at least a portion of a periphery of the recess and contacts the plate. A shape of outline of the seating portion may at least partially corresponds to a shape of an outline of the plate.

The bracket may further include a protrusion protruding outward from at least a portion of an area, corresponding to an edge of the plate, of the seating portion. A side surface of the protrusion may at least partially corresponds to a shape of an outline of the plate.

The bracket may further include a rib protruding from a bottom of the recess and contacting the plate.

The rib may extend in a direction in which the duct extends.

According to another aspect of the present disclosure, a wearable electronic device includes: a housing including a first opening and a second opening; a battery disposed in an inner space of the housing; a speaker disposed in the inner space at a side of the battery and facing the first opening; a bracket including: a base portion disposed between the battery and the speaker; and a side portion disposed between the battery and the housing and facing the second opening; and a plate disposed between the housing and the side portion of the bracket. The side portion of the bracket includes a recess being recessed inward from an outer surface of the side portion and extending toward the first opening from an area overlapping the second opening. The plate is seated on the side portion and covers at least a portion of the recess. A duct is formed by the recess and is between the side portion of the bracket and the plate, and is configured to communicate with the inner space. The plate includes a plate hole configured to allow the duct to communicate with the second opening.

The wearable electronic device may further include a first adhesive member between the side portion and the plate, and the first adhesive member may be configured to attach the plate to the side portion.

The first adhesive member may include an adhesive opening having a shape corresponding to a shape of the recess.

The duct may be defined by the recess, the plate, and the first adhesive member.

The wearable electronic device may further include a mesh member disposed outside the plate and configured to cover the plate hole.

### BRIEF DESCRIPTION OF DRAWINGS

The above and other aspects, features, and/or advantages of an embodiment of the disclosure will be more apparent from the following detailed description taken in conjunction with the accompanying drawings.

FIG. 1 is a block diagram illustrating an electronic device in a network environment according to an embodiment of the disclosure;

FIG. 2 is a block view of an audio module according to an embodiment of the disclosure;

FIG. 3 is a perspective view of a wearable electronic device according to an embodiment of the disclosure;

FIG. 4 is a perspective view of a wearable electronic device according to an embodiment of the disclosure;

FIG. 5 is a perspective view of some components of a wearable electronic device according to an embodiment of the disclosure;

FIG. 6 is an exploded perspective view of a wearable electronic device according to an embodiment of the disclosure;

FIG. 7 is a cross-sectional view of a wearable electronic device according to an embodiment of the disclosure;

FIG. 8 is a view illustrating an internal volume of a housing of a wearable electronic device according to an embodiment of the disclosure;

FIG. 9 is an enlarged cross-sectional view of some components of a wearable electronic device according to an embodiment of the disclosure;

FIG. 10 is an exploded perspective view of some components of a wearable electronic device according to an embodiment of the disclosure;

FIG. 11 is an exploded perspective view of some components of a wearable electronic device according to an embodiment of the disclosure;

FIG. 12 is a planar view of some components of a wearable electronic device according to an embodiment of the disclosure;

FIG. 13 is a perspective view and a cross-sectional view illustrating a volume of a duct of a wearable electronic device according to an embodiment of the disclosure;

FIGS. 14 through 16 are views illustrating various embodiments of a duct of a wearable electronic device according to an embodiment of the disclosure;

FIG. 17 is a graph depicting a sound pressure level of a rear sound leakage according to a duct length of a wearable electronic device according to an embodiment of the disclosure;

FIG. 18 is a graph depicting acoustic performance of a speaker according to a duct length of a wearable electronic device according to an embodiment of the disclosure;

FIG. 19 is a graph depicting acoustic performance of a speaker according to a specific acoustic impedance of some components of a wearable electronic device according to an embodiment of the disclosure;

FIG. 20 is a planar view of some components of a wearable electronic device according to an embodiment of the disclosure;

FIG. 21 is a cross-sectional view of some components of a wearable electronic device according to an embodiment of the disclosure; and

FIGS. 22 through 29 are views illustrating various embodiments of some components of a wearable electronic device according to an embodiment of the disclosure.

### DETAILED DESCRIPTION

The following description made with reference to the accompanying drawings may provide an understanding of various exemplary implementations of the disclosure including the claims and equivalents thereof. An exemplary embodiment set forth in the following description includes various particular details to help the understanding, but is considered one of various embodiments. Therefore, an ordinary person in the art will appreciate that various changes and modifications may be made to various implementations set forth herein without departing from the technical idea and scope of the disclosure. In addition, descriptions of well-known functions and configurations may be omitted for clarity and brevity.

The terms and words used in the following description and claims are not limited to bibliographical meanings, but may be used to clearly and consistently describe the various embodiments set forth herein. Therefore, it will be apparent to those skilled in the art that the following description of various implementations of the disclosure is provided only for the purpose of explanation, rather than for the purpose of limiting the disclosure defined as the scope of protection and equivalents thereto.

It should be appreciated that a singular form such as “a,” “an,” or “the” also includes the meaning as a plural form, unless the context clearly indicates otherwise. Therefore, for example, “a component surface” may mean one or more of component surfaces.

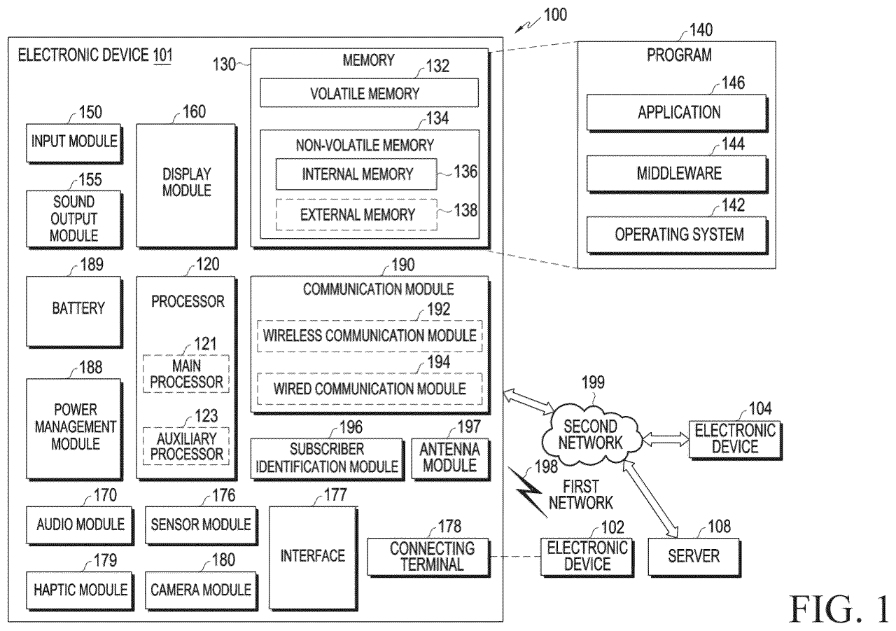

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module)./corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

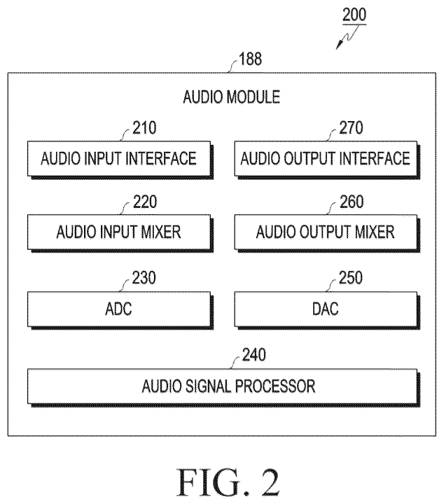

FIG. 2 is a block view of an audio module according to an embodiment of the disclosure.

Referring to FIG. 2, the audio module 170 may include, for example, an audio input interface 210, an audio input mixer 220, an analog to digital converter (ADC) 230, an audio signal processor 240, a digital to analog converter (DAC) 250, an audio output mixer 260, or an audio output interface 270.

The audio input interface 210 may receive an audio signal corresponding to a sound acquired from the outside of the electronic device 101 through a microphone (e.g., a dynamic microphone, a condenser microphone, or a piezo microphone) configured as a portion of the input module 150 or separately from the electronic device 101. For example, in case that the audio signal is acquired from an external electronic device 102 (e.g., a headset or a microphone), the audio input interface 210 may be connected to the external electronic device 102 directly through a connection terminal 178 or wirelessly (e.g., Bluetooth communication) through a wireless communication module 192 so as to receive an audio signal. According to an embodiment, the audio input interface 210 may receive a control signal (e.g., a volume adjustment signal received through an input button) associated with the audio signal acquired from the external electronic device 102. The audio input interface 210 may include multiple audio input channels and receive different audio signals for each corresponding audio input channel among the multiple audio input channels. According to an embodiment, additionally or alternatively, the audio input interface 210 may receive an audio signal from another component (e.g., the processor 120 or the memory 130) of the electronic device 101.

The audio input mixer 220 may synthesize multiple input audio signals into at least one audio signal. According to an embodiment, the audio input mixer 220 may synthesize multiple input analog audio signals input through the audio input interface 210 into at least one analog audio signal.

The ADC 230 may convert an analog audio signal into a digital audio signal. According to an embodiment, the ADC 230 may convert an analog audio signal received through the audio input interface 210 or additionally or alternatively, an analog audio signal synthesized through the audio input mixer 220 into a digital audio signal.

The audio signal processor 240 may perform various processing with respect to a digital audio signal input through the ADC 230 or a digital signal received from another component of the electronic device 101. According to an embodiment, the audio signal processor 240 may perform sampling rate modification, application of one or more filters, interpolation processing, amplification or attenuation of entire or partial frequency bands, noise processing (e.g., noise or echo attenuation), channel conversion (e.g., switching between mono and stereo), mixing, or extraction of a designated signal for one or more digital audio signals. According to an embodiment, one or more functions of the audio signal processor 240 may be implemented as the form of equalizer.

The DAC 250 may convert a digital audio signal into an analog audio signal. According to an embodiment, the DAC 250 may convert a digital audio signal processed by the audio signal processor 240 or acquired from another component (e.g., the processor 120 or the memory 130) of the electronic device 101 into an analog audio signal.

The audio output mixer 260 may synthesize multiple audio signals to be output into at least one audio signal. According to an embodiment, the audio output mixer 260 may synthesize an audio signal having been converted to analog through the DAC 250 and another analog audio signal (e.g., an analog audio signal received through the audio input interface 210) into at least one analog audio signal.

The audio output interface 270 may output an analog audio signal converted through the DAC 250 or additionally or alternatively, an analog audio signal synthesized by the audio output mixer 260 to the outside of the electronic device 101 through a sound output module 155. The sound output module 155 may include a speaker such as a dynamic driver or a balanced armature driver, or a receiver. According to an embodiment, the sound output module 155 may include multiple speakers. Here, the audio output interface 270 may output audio signals having multiple different channels (e.g., stereo or 5.1 channels) through some speakers among the multiple speakers. According to an embodiment, the audio output interface 270 may be connected to the external electronic device 102 (e.g., an external speaker or a headset) directly through the connection terminal 178 or wirelessly through the wireless communication module 192 so as to receive an audio signal.

According to an embodiment, the audio module 170 may not separate the audio input mixer 220 or the audio output mixer 260 and may generate at least one digital audio signal by synthesizing multiple digital audio signals by using at least one function of the audio signal processor 240.

According to an embodiment, the audio module 170 may include an audio amplifier (not shown) (e.g., a speaker amplification circuit) capable of amplifying an analog audio signal input through the audio input interface 210 or an audio signal to be output through the audio output interface 270. According to an embodiment, the audio amplifier may be implemented as a module separate from the audio module 170.

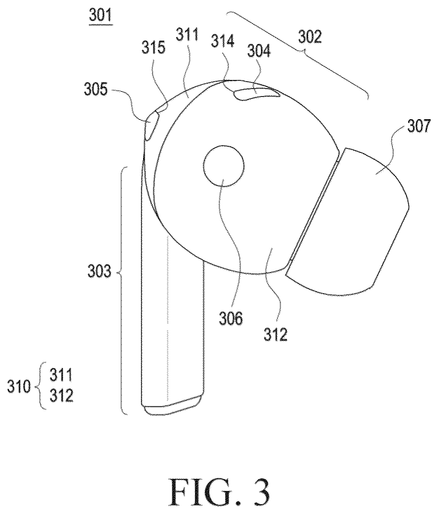

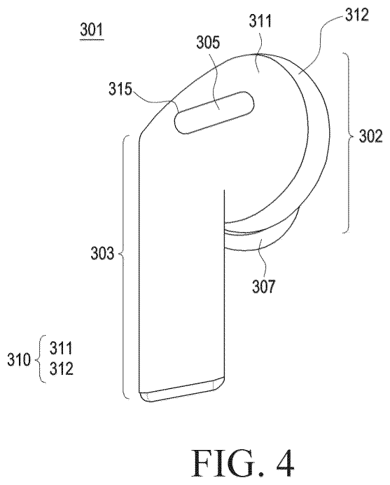

FIG. 3 is a perspective view of a wearable electronic device according to an embodiment of the disclosure. FIG. 4 is a perspective view of a wearable electronic device according to an embodiment of the disclosure.

Hereinafter, the “front portion” of the wearable electronic device 301 may refer to a surface facing the user when the user wears the wearable electronic device 301. The “rear portion” of the wearable electronic device 301 may refer to a surface facing a side opposite the user when the user wears the wearable electronic device 301.

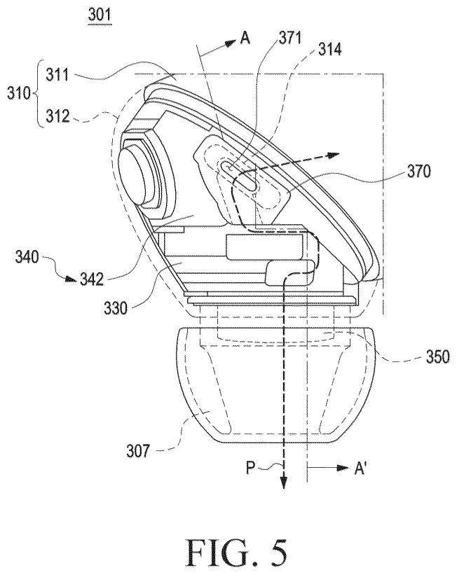

According to an embodiment, the wearable electronic device 301 may include a body portion 302 and a stem portion 303. Referring to FIGS. 3 and 4, the body portion 302 may be configured by a portion of a first housing 311 and a second housing 312. A battery (e.g., the battery 320 in FIGS. 5 through 7 and 9), a speaker (e.g., the speaker 330 in FIGS. 5 through 7, 9, and 10), or a bracket (e.g., the bracket 340 in FIGS. 5 through 7 and 9 through 11) may be arranged inside the body portion 302. The stem portion 303 may correspond to a portion protruding from the body portion 302. The stem portion 303 may be configured by the first housing 311. Electronic components such as a printed circuit board, a microphone, or an antenna may be disposed inside the stem portion 303. However, without limitation thereto, the internal configuration of the body portion 302 and the stem portion 303 may be changed. In addition, the stem portion 303 may be omitted from the wearable electronic device 301.

According to an embodiment, the wearable electronic device 301 may include a housing 310. The housing 310 may define an exterior of the wearable electronic device 301. The housing 310 may be worn on the user's ear. For example, at least a portion of the housing 310 may have a curved surface.

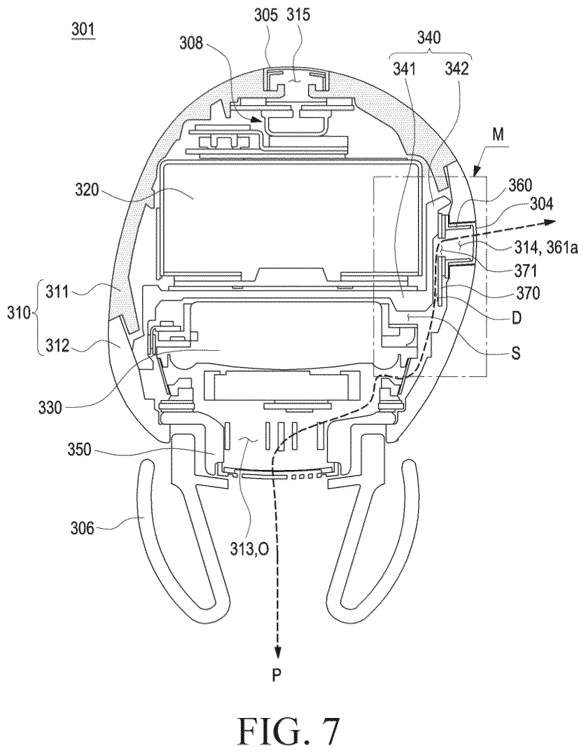

According to an embodiment, the housing 310 may include a first housing 311. The housing 310 may include a second housing 312. The first housing 311 may configure the stem portion 303 and a portion facing the side opposite the user when the wearable electronic device 301 is worn. The second housing 312 may configure a portion facing the user when the wearable electronic device 301 is worn. For example, the first housing 311 and the second housing 312 may be coupled to each other. An inner space (e.g., the inner space S in FIGS. 7 through 9) may be defined between the first housing 311 and the second housing 312. However, without limitation thereto, the first housing 311 and the second housing 312 may be integrally provided.

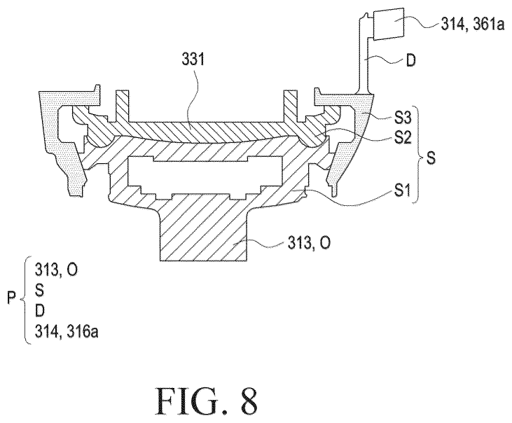

According to an embodiment, the first housing 310 may include a first opening (e.g., the first opening 313 in FIGS. 7 and 8). The first opening (e.g., the first opening 313 in FIGS. 7 and 8) may be configured through the second housing 312. The first opening will be described in detail below with reference to FIG. 7.

According to an embodiment, the housing 310 may include a second housing 314. The second opening 314 may be configured by an opening through a surface of the housing 310. For example, the second opening 314 may be configured through the second housing 312. A second port assembly (e.g., the second port assembly 360 in FIGS. 7, 9, and 10) may be coupled to the second opening 314. A sound outside the housing 310 may be introduced into the housing 310 through the second opening 314. For example, the second opening 314 may configure the other end of the acoustic duct (e.g., the acoustic duct P in FIGS. 7 and 8) inside the housing 310. A sound generated from the speaker (e.g., the speaker 330 in FIGS. 5 through 7) may be discharged to the outside through the second opening 314. The sound discharged to the outside through the second opening 314 may be referred to as the “rear sound leakage”. The second opening 314 may be exposed to the outside in a state where the wearable electronic device 301 is worn on the user's ear. Alternatively, the second opening 314 may be configured inside the first housing 311.

According to an embodiment, the housing 310 may include a third opening 315. The third opening 315 may be configured by an opening through a surface of the housing 310. For example, the third opening 315 may be configured through the first housing 311. A sound outside the housing 310 may be introduced into the housing 310 through the third opening 315. The third opening 315 may be exposed to the outside in a state where the wearable electronic device 301 is worn on the user's ear. On the other hand, the third opening 315 may be configured inside the second housing 312.

Contrary to the above description, according to an embodiment of the disclosure, the wearable electronic device 301 may be implemented with either the second opening 314 or the third opening 315 omitted, and additional openings are not excluded.

According to an embodiment, the wearable electronic device 301 may include a first grill 304. The first grill 304 may be coupled to the housing 310. For example, the first grill 304 may be disposed on the second opening 314. The first grill 304 may filter out foreign matters directed toward the second opening 314.

According to an embodiment, the wearable electronic device 301 may include a second grill 305. The second grill 305 may be coupled to the housing 310. For example, the second grill 305 may be disposed on the third opening 315. The second grill 305 may filter out foreign matters directed toward the third opening 315.

According to an embodiment, the wearable electronic device 301 may include a sensor 306. For example, the sensor 306 may be exposed through the second housing 312. The sensor 306 may be fixed to a bracket (e.g., the bracket 340 in FIGS. 5 through 7 and 9 through 11). The sensor 306 may configure a portion facing the user's skin in a state where the wearable electronic device 301 is worn on the user's skin. The sensor 306 may detect whether the wearable electronic device 301 is worn on the user's ear.

According to an embodiment, the wearable electronic device 301 may include an ear tip 307. For example, the ear tip 307 may be fixed to the first port assembly (e.g., the first port assembly 350 in FIG. 7). Alternatively, the ear tip 307 may be fixed to the housing 310. For example, the ear tip 307 may be fixed to the second housing 312. The ear tip 307 may be inserted into the user's ear.

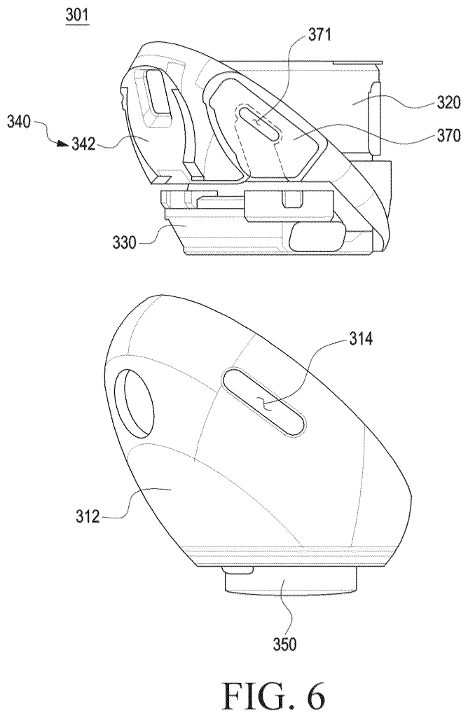

FIG. 5 is a perspective view of some components of a wearable electronic device according to an embodiment of the disclosure. FIG. 6 is an exploded perspective view of a wearable electronic device according to an embodiment of the disclosure. FIG. 7 is a cross-sectional view of a wearable electronic device according to an embodiment of the disclosure. FIG. 8 is a view illustrating an internal volume of a housing of a wearable electronic device according to an embodiment of the disclosure.

Specifically, FIG. 5 is an enlarged view of the second housing 312 area of the wearable electronic device 301, wherein the second housing 312, the ear tip 307, and first port assembly 350 are depicted semi-transparently to reveal the internal side of the second housing 312 and the ear tip 307. FIG. 6 is a view illustrating the second housing 312 in an exploded state. FIG. 7 is a cross-sectional view of FIG. 5 taken along line A-A′. FIG. 8 shows a volume of a side of the bracket 340, facing a first opening 313, and a volume of a side of the bracket 340, facing a second opening 314.

According to an embodiment of the disclosure, the wearable electronic device 301 may include a housing 310, a battery 320, a speaker 330, a bracket 340, a first port assembly 350, a second port assembly 360, a plate 370, a compression member 380, but may be implemented without some of the components and additional components are not excluded.

According to an embodiment, the housing 310 may include an inner space S. The microphone 308, the battery 320, the speaker 330, and the bracket 340 may be arranged in the inner space S. For example, the inner space S may be defined by the first housing 311 and the second housing 312.

According to an embodiment, the housing 310 may include a first opening 313. The first opening 313 may be configured by an opening through a surface of the housing 310. For example, the first opening 313 may be configured on the second housing 312. For example, the first port assembly 350 may be fixed to or connected to the first opening 313. For example, the first opening 313 may configure one end of the acoustic duct P (e.g., an output duct O) inside the housing 310. A sound generated from the speaker 330 may be discharged to the outside through the first opening 313.

According to an embodiment, the wearable electronic device 301 may include the battery 320. The battery 320 may be disposed in the inner space S of the housing 310. The battery 320 may supply power to electronic components disposed inside the housing 310, such as the speaker 330 or the microphone 308.

According to an embodiment, the wearable electronic device 301 may include the speaker 330. The speaker 330 may be disposed in the inner space S of the housing 310. The speaker 330 may be arranged at a side of the battery 320, facing the first opening 313. The speaker 330 may generate a sound. The sound generated from the speaker 330 may be transferred to the outside through the first opening 313, the first port assembly 350 and/or the ear tip 307.

According to an embodiment, the speaker 330 may include a membrane 331. The membrane 331 may be referred to as a diaphragm. The membrane 331 may be vibrated by receiving an electrical signal. The vibration of the membrane 331 may generate a sound. Based on the membrane 331, a front side volume S1 and a second rear side volume S3 may be divided.

According to an embodiment, the wearable electronic device 301 may include the bracket 340. The bracket 340 may be disposed in the inner space S of the housing 310. The bracket 340 may function as a structure configured to support components, such as the battery 320 and the speaker 330 inside the housing 310. The bracket 340 may be made of a plastic material or metal material and other materials may not be excluded.

According to an embodiment, the bracket 340 may include a base portion 341. The base portion 341 may be disposed between the battery 320 and the speaker 330. The base portion 341 may have a plate shape.

According to an embodiment, the bracket 340 may include a side portion 342. The side portion 342 may extend from the base portion 341 to an opposite side of the first opening 313. For example, the side portion 342 may extend from an edge of the base portion 341 to an opposite side of the first opening 313. The side portion 342 may be disposed on a side portion of the battery 320. For example, the side portion 342 may be disposed between a side surface of the battery 320 and the housing 310. The side portion 342 may face the second opening 314. For example, the side portion 342 may be provided at a position overlapping the second opening 314.

According to an embodiment, the wearable electronic device 301 may include the first port assembly 350. The first port assembly 350 may protrude to an outer side of the housing 310. For example, the first port assembly 350 may protrude to an outer side of the second housing 312. The first port assembly 350 may be coupled to the second housing 312. The first port assembly 350 may be disposed inside the first opening 313. Contrary to the above description, the first port assembly 350 and the second housing 312 may be integrally configured. For example, the first port assembly 350 may correspond to a portion of the second housing 312.

According to an embodiment, an output duct O may be configured inside the first port assembly 350. The output duct O may face the speaker 330. The output duct O may extend through the first port assembly 350 along an output direction of the speaker 330. The sound generated from the speaker 330 may be transferred to the outside of the housing 310 through the output duct O.

According to an embodiment, the output duct O may correspond to a space at least partially overlapping the first opening 313. For example, the output duct O may be disposed inside the first opening 313. Specifically, the first port assembly 350 is disposed inside the first opening 313 and thus, it may be understood that the output duct O configured in the first port assembly 350 is disposed inside the first opening 313. However, without limitation thereto, in case that the first port assembly 350 and the second housing 312 are integrally configured, the first opening 313 may be defined by the output duct O. For example, the output duct O and the first opening 313 may be understood to be the same.

According to an embodiment, the wearable electronic device 301 may include the second port assembly 360. The second port assembly 360 may be coupled to the housing 310. For example, the second port assembly 360 may be coupled to the second opening 314 of the second housing 312. At least a portion of the second port assembly 360 may be disposed inside the second opening 314. For example, at least a portion of the second port assembly 360 may be inserted into the second opening 314 inside the housing 310.

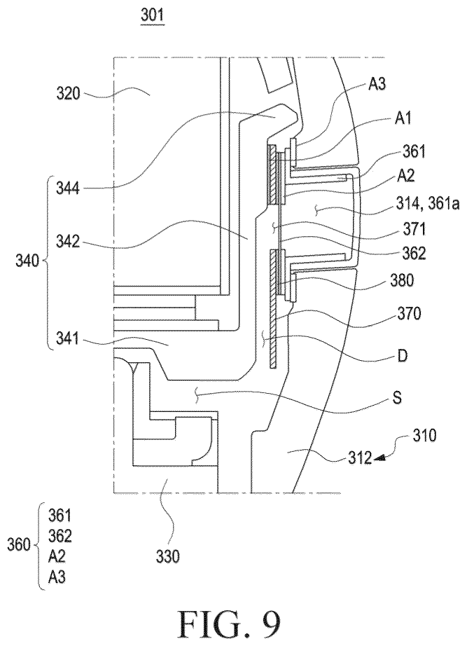

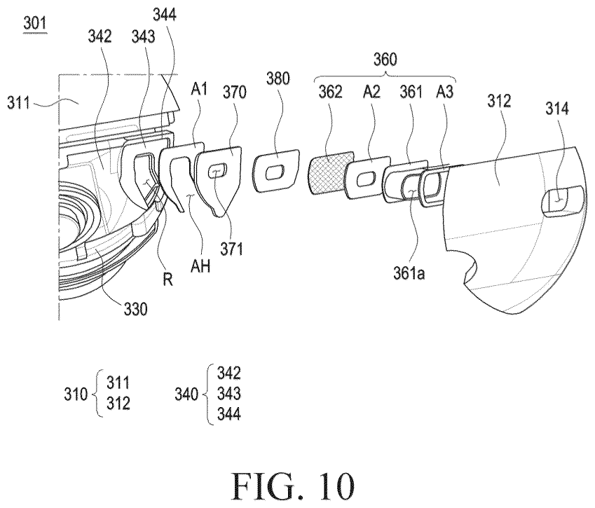

According to an embodiment, a port hole 361a may be configured inside the second port assembly 360. For example, the port hole 361a may extend through a vent port (e.g., the vent port 361 in FIGS. 9 and 10) of the second port assembly 360. The port hole 361a may be configured in a direction facing a plate hole 371. A description of the port hole 361a will be made with reference to FIGS. 9 and 10.

According to an embodiment, the wearable electronic device 301 may include the plate 370. The plate 370 may be disposed between the housing 310 and the side portion 342 of the bracket 340. The plate 370 may define at least a portion of a duct D.

According to an embodiment, the plate hole 371 may be configured on the plate 370. The plate hole 371 may allow the duct D to communicate with the second opening 314. For example, the duct D and the second opening 314 may communicate with each other through the plate hole 371.

According to an embodiment, the wearable electronic device 301 may include the microphone 308. The microphone 308 may be disposed inside the housing 310. The microphone 308 may be disposed adjacent to the third opening 315. The microphone 308 may receive a sound from the outside of the housing 310. For example, the microphone 308 may receive a sound introduced into the housing 310 through the first grill 304 coupled to the third opening 315. For example, the microphone 308 may perform an active noise cancellation (ANC) function.

According to an embodiment, the wearable electronic device 301 may include an additional microphone. For example, the wearable electronic device 301 may include an internal microphone 308 disposed adjacent to the speaker 330 and the microphone 308 disposed inside the housing 311 at an end area of the stem portion (e.g., the stem portion 303 in FIGS. 3 and 4).

According to an embodiment, the sound received by the microphone 308 may be transferred to a signal processing device (e.g., the audio signal processor 240 in FIG. 2). The signal processing device may analyze the sound received by the microphone 308 in the form of an analog or digital signal. The signal for the sound having been processed by the signal processing device may be converted by a converter (e.g., the DAC 250 in FIG. 2). For example, the converter may convert a digital signal for the sound having been processed by the signal processing device into an analog signal.

According to an embodiment, the wearable electronic device 301 may include an antenna (e.g., the antenna 197 in FIG. 1). The antenna may be disposed inside the housing 310. For example, the antenna may be disposed inside the first housing 311. For example, the antenna may be disposed in the stem portion 303. However, alternatively, the antenna may be disposed in the body portion 302. The antenna may transmit and/or receive a signal.

According to an embodiment, the wearable electronic device 301 may include a substrate. The substrate may be disposed inside the housing 310. Multiple substrates may be provided. For example, the substrate may be electrically connected to the battery 320, the speaker 330, the sensor 306, the microphone 308, and/or the antenna.

According to an embodiment, the acoustic duct P may be configured in the housing 310. The acoustic duct P may be communicated between the first opening 313 and the second opening 314. For example, referring to FIG. 8, the acoustic duct P may include at least a portion (e.g., the front side volume S1, the first rear side volume S2, and second rear side volume S3 in FIG. 8) of the inner space S of the housing 310, the duct D, and the port hole 361a (or the second opening 314) and the output duct O (or the first opening 313). The acoustic duct P may represent an empty space extending from the output duct O to the second opening 314 via the inner space S. The acoustic duct p may be referred to as a “duct”. The acoustic duct p may be referred to as a “bypass passage”. The acoustic duct p may be referred to as a “vent hole”. The acoustic duct p may be referred to as a “sound passage”. The acoustic duct p may be referred to as a “tunnel”. The acoustic duct p may be referred to as a “flow passage”. When the wearable electronic device 301 is worn on the user's ear, since the inside and outside of the user's ear may be communicated through the acoustic duct P, the feeling of ear fullness may be improved.

According to an embodiment, the acoustic duct P may include the front side volume S1. The front side volume S1 may represent a first opening 313-side space of the membrane 331 of the speaker 330. The front side volume S1 may be communicated with the inner space S and may be understood as a portion of the inner space S.

According to an embodiment, the acoustic duct P may include the first rear side volume S2. The first rear side volume S2 may represent a bracket 340-side space of the membrane 331 of the speaker 330. The first rear side volume S2 may be communicated with the inner space S and may be understood as a portion of the inner space S.

According to an embodiment, the acoustic duct P may include the second rear side volume S3. The second rear side volume S3 may represent a space between a side surface of the speaker 330 and the housing 310. The second rear side volume S3 may be understood as a portion of the inner space S. The front side volume S1, the first rear side volume S2, and the second rear side volume S3 may be communicated with each other.

According to an embodiment, the acoustic duct P may include the output duct O. The output duct O may be communicated with the inner space S. For example, the output duct O may be communicated with the front side volume S1.

According to an embodiment, the acoustic duct P may include the duct D. The duct D may extend from the inner space S of the housing 310 toward the second opening 314. The duct D may be communicated with the inner space S. For example, the duct D may be communicated with the second rear side volume S3. The duct D may be communicated with the second opening 314.

According to an embodiment, the duct D may be disposed between the side portion 342 of the bracket 340 and the plate 370. For example, the duct D may be defined by the plate 370 and the recess R disposed on the side portion 342 of the bracket 340. As such, the duct D is configured using the bracket 340 which is a component of the wearable electronic device 301, improving the inner space efficiency of the housing 310. However, without limitation thereto, the duct D may be configured by a separated pipe member.

According to an embodiment, the duct D may control the rear sound leakage caused by the speaker 330. Specifically, the rear sound leakage caused by the speaker 330 may flow outward of the second opening 314 through the duct D. Here, in case that the specific acoustic impedance of the duct D and/or the specific acoustic impedance between the duct D and the second opening 314 becomes smaller, the sound pressure level of the rear sound leakage may be reduced, and in case that the specific acoustic impedance of the duct D and/or the specific acoustic impedance between the duct D and the second opening 314 becomes greater, the sound pressure level of the rear sound leakage may be increased. As such, the sound pressure level of the rear sound leakage may be controlled through the appropriate design of the duct D.

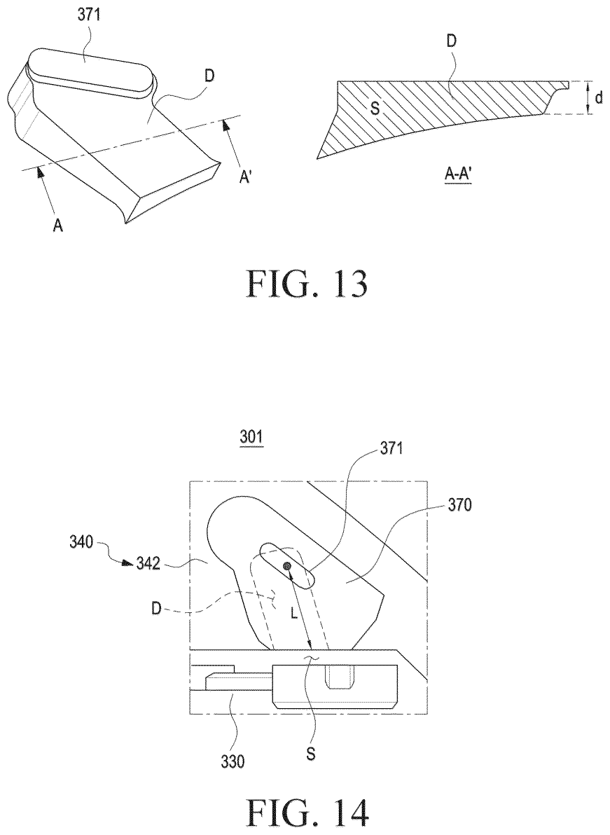

According to an embodiment, the acoustic performance of the speaker 330 may be improved through the duct D. Specifically, a load applied to the rear surface of the speaker 330 may be controlled through the duct D. For example, when the specific acoustic impedance of the duct D and/or the specific acoustic impedance between the duct D and the second opening 314 is increased, a load applied to the speaker 330 may be increased and accordingly, the acoustic performance of the speaker 330 may be reduced. Meanwhile, when the specific acoustic impedance of the duct D is reduced, a load applied to the speaker 330 may be reduced and accordingly, the acoustic performance of the speaker 330 may be increased. As such, the acoustic performance of the wearable electronic device may be improved through the appropriate design of the duct D. The description thereof will the given below with reference to FIGS. 14 through 19.

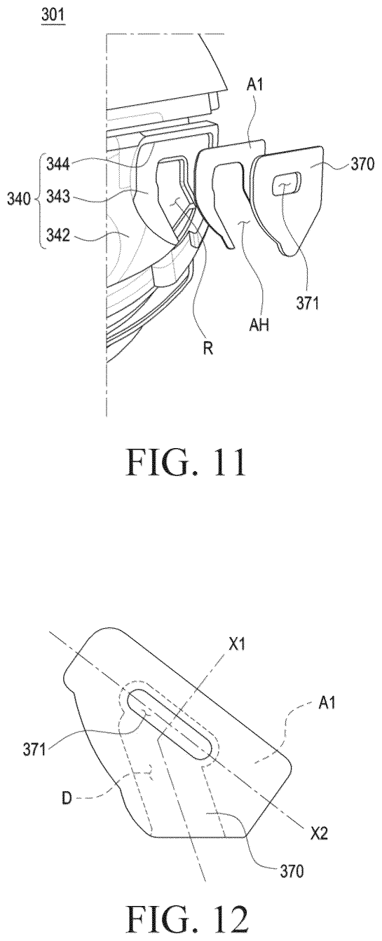

FIG. 9 is an enlarged cross-sectional view of some components of a wearable electronic device according to an embodiment of the disclosure. FIG. 10 is an exploded perspective view of some components of a wearable electronic device according to an embodiment of the disclosure. FIG. 11 is an exploded perspective view of some components of a wearable electronic device according to an embodiment of the disclosure. FIG. 12 is a planar view of some components of a wearable electronic device according to an embodiment of the disclosure. FIG. 13 is a perspective view and a cross-sectional view illustrating a volume of a duct of a wearable electronic device according to an embodiment of the disclosure.

Specifically, FIG. 9 is an enlarged cross-sectional view of area M of FIG. 7. FIG. 10 is an exploded view illustrating a configuration of an area of the recess R and the second opening 314 disposed on the bracket 340. FIG. 11 is an exploded view illustrating a portion of the recess R or the plate 370 of FIG. 10. FIG. 12 shows a shape of the duct D as viewed from the front. FIG. 13 is a view illustrating the volume of the duct D and a cross-section of the duct D.

According to an embodiment, the wearable electronic device 301 may include the plate 370. The plate 370 may be disposed between the housing 310 and the side portion 342 of the bracket 340. For example, the side portion 342 may be seated on the plate 370. For example, the plate 370 may be seated on a seating portion 343 disposed on the side portion 342 of the bracket 340.

According to an embodiment, the plate 370 may be coupled to the side portion 342. For example, the plate 370 may be coupled to the seating portion 343 disposed on the side portion 342 of the bracket 340. For example, the plate 370 may be attached to the side portion 342 through a first adhesive member A1. However, without limitation thereto, the plate 370 may be coupled to the side portion 342 through a separate mechanical mechanism.

According to another embodiment, the plate 370 may cover at least a portion of the recess R. For example, the plate 370 may cover a portion of the recess R excluding a portion overlapping the plate hole 371. However, in contrast, depending on the required size or length of the duct D, there may be a portion of the recess R that is not covered by the plate 370, in addition to the portion overlapping the plate hole 371.

According to an embodiment, the plate 370 may include the plate hole 371. The plate hole 371 may allow the duct D to communicate with the second opening 314. The specific acoustic impedance between the duct D and the second opening 314 may be adjusted according to the size of the plate hole 371. For example, as the plate hole 371 increases in size, the specific acoustic impedance between the duct D and the second opening 314 may decrease, whereas as the plate hole 371 decreases in size, the specific acoustic impedance between the duct D and the second opening 314 may increase. For example, the area of the plate hole 371 may be about 1.4 mm².

According to an embodiment, the plate hole 371 may be configured to have a rectangular shape. For example, the plate hole 371 may have a shape extending in a direction X2 intersecting an extension direction X1 of the duct D. Referring to FIG. 2, the plate hole 371 may have a rectangular shape extending in the direction X2 intersecting the extension direction X1 of the duct D. As the plate hole 371 is configured to have a short width along the extension direction X1 of the duct D, the length of the duct D may be easily adjusted. Therefore, the length of the duct D is easily adjusted and the specific acoustic impedance of the duct D may be easily adjusted as well. In addition, as the plate hole 371 is configured elongated in the direction X2 intersecting the extension direction X1 of the duct D, the plate hole 371 may be configured to have a sufficient size. As the plate hole 371 is configured to have a sufficient size, an appropriate specific acoustic impedance between the duct D and the second opening 314 may be configured.

According to an embodiment, the plate 370 may include at least one of steel use stainless (SUS), steel plate cold rolled commercial (SPCC), polycarbonate (PC), or polyethyleneterephthalate (PET). For example, the plate 370 may include a combination of SUS, SPCC, PC or PET. For example, the plate 370 may be configured of SUS or SPCC. Here, since sufficient rigidity of the plate 370 may be secured, the durability of the wearable electronic device 301 may be improved. On the contrary, the plate 370 may be configured of a PC sheet or a PET sheet. Here, since the manufacturing cost of the plate 370 may be reduced, it may be advantageous in terms of cost. However, the material of the plate 370 is not limited to the aforementioned SUS, SPCC, PC sheet and/or PET sheet.

According to an embodiment, the bracket 340 may include the recess R. The recess R may be configured on the side portion 342. The recess R may be configured to be recessed inward from an outer peripheral surface of the side portion 342. The recess R may extend toward the first opening 313 in an area overlapping the second opening 314. For example, the recess R may extend from an area overlapping the second opening 314 to a first opening 313-side edge of the side portion 342.

According to an embodiment, the specific acoustic impedance of the duct D may be adjusted according to the depth of the recess R. For example, as the recess R becomes deeper, the cross-sectional area of the duct D increases, which may reduce the specific acoustic impedance of the duct D, and as the recess R becomes shallower, the cross-sectional area of the duct D decreases, which may increase the specific acoustic impedance.

According to an embodiment, the bracket 340 may include the seating portion 343. The seating portion 343 may be configured on the side portion 342. The seating portion 343 may be disposed on at least a portion around the recess R. For example, the seating portion 343 may be configured to surround the remaining portion excluding a first opening 313-side end portion of the recess R. The plate 370 may be in close contact with the seating portion 343 For example, the plate 370 may be attached to the seating portion 343

According to an embodiment, the seating portion 343 may extend to be parallel to the plate 370. For example, in case that the plate 370 has a flat plate shape, the seating portion 343 may have a flat shape in response thereto. However, without limitation thereto, in case that the plate 370 has a curved shape, the seating portion 343 may have a curved shape in response thereto. Therefore, the plate 370 may be stably coupled (or attached) to the seating portion 343.

According to an embodiment, an outline of the seating portion 343 and an outline of the plate 370 may at least partially correspond to each other. For example, a portion of the outline of the seating portion 343 excluding a portion where the recess R is configured may correspond to the outline of the plate 370. For example, referring to FIGS. 10 and 12, the plate 370 may have an approximately pentagonal shape and the seating portion 343 may be provided to have an about pentagonal shape in response thereto. Accordingly, an attachment position of the plate 370 may be easily guided.

According to an embodiment, the bracket 340 may include a protrusion 344. The protrusion 344 may protrude outward from at least a portion of an area corresponding to the edge of the plate 370. For example, referring to FIGS. 9 through 11, the protrusion 344 may protrude from an upper edge of the seating portion 343. However, without limitation thereto, the protrusion 344 may protrude outward from a predetermined area of the edge of the seating portion 343.

According to an embodiment, a side surface of the protrusion 344 and the outline of the plate 370 may at least partially correspond to each other. For example, referring to FIGS. 9 through 11, the upper edge of the seating portion 343 may have a shape corresponding to the upper edge of the plate 370, and the protrusion 344 may protrude outward from the upper edge of the seating portion 343. Through this, a shape of the side surface of the seating portion 343 may correspond to the upper edge of the plate 370. Accordingly, a position of the plate 370 may be guided in a process in which the plate 370 is coupled (or attached) to the seating portion 343.

According to an embodiment, the wearable electronic device 301 may include the first adhesive member A1. The first adhesive member A1 may be disposed between the side portion 342 and the plate 370. For example, the first adhesive member A1 may be disposed on the seating portion 343 configured on the side portion 342. For example, the first adhesive member A1 may be disposed on an inner wall surface of the plate 370. The first adhesive member A1 may attached the plate 370 to the side portion 342.

According to an embodiment, the first adhesive member A1 may include an adhesive opening AH. The adhesive opening AH may be understood as a cavity portion extending through the first adhesive member A1. The adhesive opening AH may have a shape corresponding to the shape of the recess R. For example, referring to FIG. 11, the recess R may extend to have a curved shape on the side portion 342, and the adhesive opening AH may have a curved shape corresponding thereto. The adhesive opening AH may define a portion of the duct D. At least a portion of the adhesive opening AH may overlap the plate hole 371 of the plate 370.

According to an embodiment, the first adhesive member A1 may be provided as at least one of double-sided tape, bond, glue, or adhesive. For example, the first adhesive member A1 may be provided as a double-sided tape. In case that the first adhesive member A1 is provided as a double-sided tape, the first adhesive member A1 including the adhesive opening AH may be precisely shaped to as to prevent a portion of the first adhesive member A1 from being pushed into the duct D and affecting the size of the duct D. In addition, in case that the first adhesive member A1 is provided as a double-sided tape, the application of the first adhesive member A1 may be easy even if the seating portion 343 to which the plate 370 is attached has a curved shape. In addition, in a case that the first adhesive member A1 is provided as a double-sided tape, a separate drying process may be omitted and thus the ease of assembly of the wearable electronic device 301 may be improved. Furthermore, in case that the first adhesive member A1 is provided as a double-sided tape, the attachment and detachment of the plate 370 is easy to improve the ease of re-assembly. However, without limitation thereto, the plate 370 may be attached to the side portion 342 in a boding manner. For example, the first adhesive member A1 may be implemented as a material, such as a bond, glue, or adhesive, if the material allows the thickness and/or shape of the first adhesive member A1 to be precisely adjusted, enables rapid drying, and facilitates the attachment and detachment of the plate 370.

According to an embodiment, a cross-sectional area of the duct D may be adjusted according to the thickness of the first adhesive member A1, and consequently, the specific acoustic impedance of the duct D may be controlled. For example, in case that the first adhesive member A1 have a thickness of about 0.05 T, a minimum depth d of the duct D may be about 0.15 T and a cross-sectional area s of the duct D may be about 0.4 mm². For example, in case that the first adhesive member A1 has a thickness of about 0.15 T, a minimum depth d of the duct D may be about 0.25 T and a cross-sectional area s of the duct D may be about 0.55 mm². For example, in case that the first adhesive member A1 have a thickness of about 0.25 T, a minimum depth d of the duct D may be about 0.35 T and a cross-sectional area s of the duct D may be about 0.71 mm². From the perspective of reducing the specific acoustic impedance of the duct D, a thicker first adhesive member A1 may be advantageous to increase the cross-sectional area of the duct D. However, from the perspective of securing the durability of a structure of the duct D, the cross-sectional area of the duct D may be adjusted using the depth of the recess R and the first adhesive member A1 may be used as an auxiliary component for securing the cross-sectional area of the duct D.

According to an embodiment, the acoustic duct (e.g., the acoustic duct P in FIGS. 7 and 8) may include the duct D. The duct D may be defined by the plate 370 and the recess R. For example, the duct D may be configured by the plate 370 covering a concave portion configured by the recess R. For example, in the case of the structure in which the plate 370 is coupled to the side portion 342 without the first adhesive member A1, the duct D may be defined only by the recess R and the plate 370.

According to an embodiment, the duct D may be defined by the recess R, the plate 370, and the first adhesive member A1. For example, the duct D may be configured by the plate 370 covering a concave portion configured by the recess R and the first adhesive member A1 configured to have a shape corresponding to the recess R. In this case, the cross-sectional area of the duct D may be adjusted by the thickness of the first adhesive member A1.

According to an embodiment, the duct D may be communicated with the inner space S. For example, a first opening 313-side end portion of the duct D may be communicated with the inner space S (e.g., the second rear volume S3 in FIG. 8).

According to an embodiment, the wearable electronic device 301 may include a mesh member 362. The mesh member 362 may be disposed outside the plate 370. For example, the mesh member 362 may be disposed between the plate 370 and the vent port 361 (or the second opening 314). The mesh member 362 may include a material through which a sound (or air) passes.

According to an embodiment, the mesh member 362 may cover the plate hole 371. The mesh member 362 may be provided to have a size at least larger than the plate hole 371.

According to an embodiment, a specific acoustic impedance between the duct D and the external environment may be controlled by the mesh member 362. For example, an specific acoustic impedance between the duct D and the second opening 314 may be controlled according to the number of mesh counts, a size of the opening, an open rate, a thickness, and air permeability of the mesh member 362.

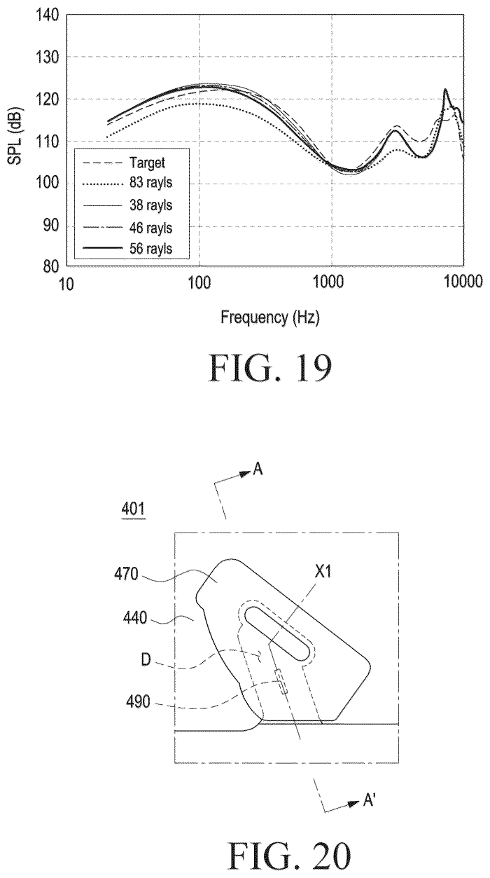

According to an embodiment, the specific acoustic impedance between the duct D and the second opening 314 may be determined by a complex combination of characteristics of the plate hole 371 and characteristics of the mesh member 362. Frequency response characteristics of the speaker according to the specific acoustic impedance between the duct D and the second opening 314 determined by the plate hole 371 and the mesh member 362 will be described below with reference to FIG. 19.

According to an embodiment, the mesh member 362 may correspond to a component of the second port assembly 360. For example, the mesh member 362 may be attached to a vent port 361 disposed on the outside of the mesh member 362 by a second adhesive member A2. However, without limitation thereto, the mesh member 362 may be coupled to the vent port 361 through a separate mechanical mechanism. During the assembly process of the wearable electronic device 301, the mesh member 362 may be coupled (or attached) to the vent port 361 attached to the second housing 312 before the second housing 312 is coupled to the first housing 311.

Contrary to the above description, in case that the desired specific acoustic impedance may be achieved just by adjusting the size of the plate hole 371, the mesh member 362 may not be provided.

According to an embodiment, the wearable electronic device 301 may include a waterproof member. The waterproof member may be disposed outside the plate 370. For example, the waterproof member may be disposed between the plate 370 and the vent port 361 (or the second opening 314). The waterproof member may be configured of a material which allows a sound (or air) to pass through, but not moisture easily.

According to an embodiment, the waterproof member and the mesh member 362 may be selectively provided. Both the waterproof member and the mesh member 362 are components for increasing the specific acoustic impedance between the duct D and the second opening 314, and in case that all of two components are used, the specific acoustic impedance between the duct D and the second opening 314 may be excessively increased and thus the waterproof member and the mesh member 362 may be selectively provided. For example, referring to FIGS. 9 and 10, in case that the waterproof member is provided instead of the mesh member 362, the waterproof member may be disposed at a position of the mesh member 362. A specific placement relationship and shape of the waterproofing member may be identical or similar to those of the mesh member 362. However, without limitation thereto, both the mesh member 362 and the waterproof member may be concurrently provided in case that the specific acoustic impedance between the duct D and the second opening 314 may be designed to have an appropriate value even if both the mesh member 362 and the waterproof member are concurrently provided. For example, in case that both the mesh member 362 and the waterproof member are concurrently provided, the waterproof member may be disposed inside and/or outside the mesh member 362.

According to an embodiment, the wearable electronic device 301 may include the vent port 361. The vent port 361 may be disposed outside the mesh member 362. For example, the vent port 361 may be disposed between the mesh member 362 and the second housing 312.

According to an embodiment, the vent port 361 may be disposed inside the second opening 314. For example, the vent port 361 may be inserted into the second opening 314 inside the second housing 312.

According to an embodiment, the port hole 361a may be configured inside the vent port 361. The port hole 361a may extend through the vent port 361. The port hole 361a may be configured in a direction facing a plate hole 371.

According to an embodiment, the second opening 314 may be defined by the port hole 361a. For example, the port hole 361a may correspond to a space at least partially overlapping the second opening 314. Specifically, since the vent port 361 is disposed inside the second opening 314, the port hole 361a may be disposed inside the second opening 314. For example, in case that there is no gap between an outer circumferential surface of the vent port 361 and the second opening 314, the second opening 314 may be understood as the same as the port hole 361a. Contrary to the above description, in case that the vent port 361a does not have a structure inserted into the second opening 314, the second opening 314 may be defined as the second housing 312, the port hole 361a may be configured as a space separated from the second opening 314, and the port hole 361a may be communicated with the second opening 314.

According to an embodiment, the vent port 361 may correspond to a component of the second port assembly 360. For example, the mesh member 362 may be attached on the inner side of the vent port 361 by the second adhesive member A2, and the vent port 361 may be attached on the inner surface of the housing 310 (e.g., the second housing 312) through a third adhesive member A3. However, without limitation thereto, the vent port 361 may be coupled to the inner surface of the housing 310 (e.g., the second housing 312) through a separate mechanical mechanism. During an assembly process of the wearable electronic device 301, the vent port 361, with the mesh member 362 coupled (or attached) to the inner side thereof, may be attached to the inner side of the second housing 312 before the second housing 312 is coupled to the first housing 311.

According to an embodiment, the second adhesive member A2, which attaches the mesh member 362 (or the waterproof member) to the vent port 361, and/or the third adhesive member A3, which attaches the vent port 361 to the second housing (312), may be more advantageous when made thinner. As the second adhesive member A2 and the third adhesive member A3 become thinner, the space occupied by the second port assembly 360 inside the housing 310 may be reduced. Specifically, the space between the second housing 312 and the side portion 342 of the bracket 340 may be small. Here, in order to secure the size of the duct D, it may be desirable to design the first adhesive member A1 and the second adhesive member A2 to be as thin as possible, minimizing the space occupied by the second port assembly 360 inside the housing 310. For example, the thickness of the second adhesive member A2 and/or the third adhesive member A3 may be 0.05 T.

According to an embodiment, the wearable electronic device 301 may include the compression member 380. The compression member 380 may be disposed outside the plate 370. For example, the compression member 380 may be disposed between the plate 370 and the mesh member 362 (or the waterproof member). The compression member 380 may be compressed by the plate 370 and the second port assembly 360 as the second housing 312 and the first housing 311 are assembled. A compression repulsion force may occur in the compression member 380, and the compression repulsion may press the plate 370 toward the side portion 342 of the bracket 340 and the second port assembly 360 toward the second housing 312. Through this, the plate 370 and the second port assembly 360 may be stably fixed, and displacement of detailed components of the plate 370 and the second port assembly 360 may be prevented. In addition, through the structure in which the plate 370, the compression member 380, and the second port assembly 360 overlap and pressurize each other, the sealing performance of the acoustic duct (e.g., the acoustic duct P in FIGS. 7 and 8) extending from the duct D to the second opening 314 may be improved.

According to an embodiment, the compression member 380 is pressurized by the plate 370 and the second port assembly 360 so as to be fixed between the plate 370 and the second port assembly 360. However, without limitation thereto, the compression member 380 may be attached to the plate 370 or attached to the mesh member 362 (or the waterproof member) by an adhesive member.

According to an embodiment, the compression member 380 may include a soft material. For example, the compression member 380 may include a material having elastic resilience. For example, the compression member 380 may include a sponge, foam, or rubber material. Since the compression member 380 includes a soft material, the compression resilience applied to the plate 370 and the second port assembly 360 by the compression member 380 may be improved, and the sealing performance of the acoustic duct (e.g., the acoustic duct P in FIGS. 7 and 8) may be improved. The compression member 380 may be referred to as a Poron member.

Contrary to the above description, in case that sufficient pressing force is applied between the plate 370 and the second port assembly 360 as the second housing 312 and the first housing 311 are assembled, the compression member 380 may not be provided.

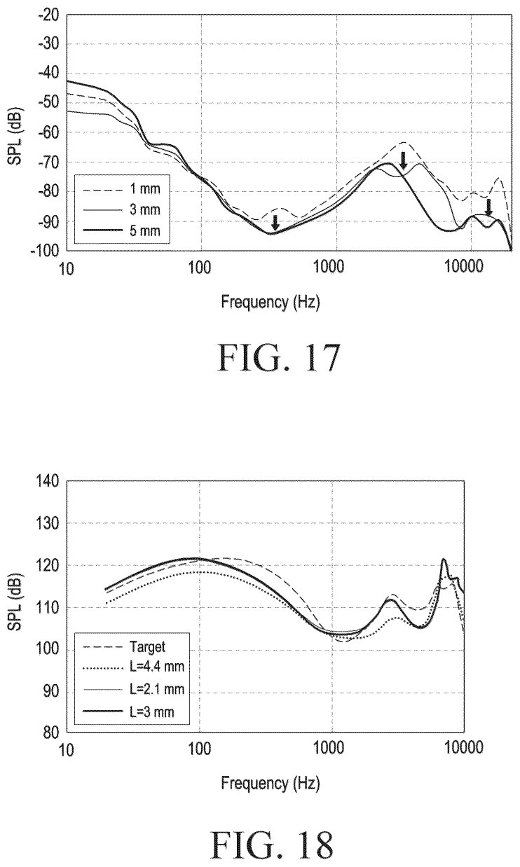

FIGS. 14 through 16 are views illustrating various examples of a duct of a wearable electronic device according to an embodiment of the disclosure. FIG. 17 is a graph depicting a sound pressure level of a rear sound leakage according to a duct length of a wearable electronic device according to an embodiment of the disclosure. FIG. 18 is a graph depicting acoustic performance of a speaker according to a duct length of a wearable electronic device according to an embodiment of the disclosure.

Hereinafter, a length between a point of the duct D, corresponding to the central portion of the plate hole 371 and the end of the duct D at the side toward the first opening (e.g., the first opening 313 in FIG. 7) may be referred to as a “duct length L”.

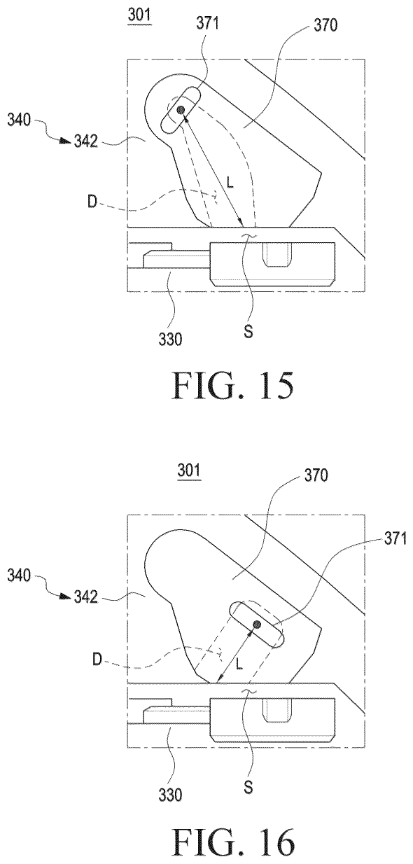

According to an embodiment, the duct length L may be variously configured. For example, referring to FIGS. 14 and 15, the duct length L of the duct D shown in FIG. 15 may be longer than the duct length L of the duct D shown in FIG. 14. For example, referring to FIGS. 14 and 16, the duct length L of the duct D shown in FIG. 16 may be shorter than the duct length L of the duct D shown in FIG. 14.

According to an embodiment, the acoustic performance of the speaker 330 may be changed according to the duct length L. For example, as the duct length L becomes longer, the load applied to the speaker 330 may increase. When the load applied to the speaker 330 becomes greater, the movement of the membrane 331 of the speaker 330 may have limitation, thereby reducing the acoustic performance. On the contrary, as the duct length L becomes shorter, the load applied to the speaker 330 may decrease. When the load applied to the speaker 330 becomes smaller, the limitation on the movement of the membrane 331 of the speaker 330 may be reduced, thereby increasing the acoustic performance.

According to an embodiment, the level of the rear sound leakage through the second opening (e.g., the second opening 314 in FIGS. 5 through 10) may change according to the duct length L. For example, when the duct length L becomes longer, a passage through which the rear sound leakage passes becomes longer, thereby reducing the rear sound leakage. On the other hand, when the duct length L becomes shorter, a passage through which the rear sound leakage passes becomes shorter, thereby increasing the rear sound leakage.

In summary, when the duct length L becomes longer, the rear sound leakage may be reduced and the acoustic performance of the speaker 330 may decrease. On the contrary, when the duct length L becomes shorter, the rear sound leakage may be increased and the acoustic performance of the speaker 330 may be improved. Therefore, in order to secure the desired acoustic performance while appropriately controlling the rear sound leakage, an appropriate design of the duct length L may be required.

FIG. 17 is a graph depicting a rear sound leakage according to a duct length L.

Specifically, in the graph in FIG. 17, the X-axis represents frequency (Hz) and the Y-axis represents the sound pressure level (SPL) (dB) of the rear leakage sound.

Referring to FIG. 17, it may be identified that as the duct length L becomes longer, the overall sound pressure level of rear sound leakage decreases. Particularly, it may be identified that in the practical audible frequency range above 100 Hz, the sound pressure level of rear sound leakage is reduced when the duct length L is 3 mm or 5 mm, compared to when the duct length L is 1 mm. Particularly, it may be identified that in the band around 200 Hz and above 2000 Hz, the rear leakage sound is effectively controlled as the duct length L becomes longer.

FIG. 18 illustrates the graph showing frequency response (frequency reaction) (FR) characteristics and target frequency response characteristics of the speaker according to the duct length L.

Specifically, in the graph in FIG. 18, the X-axis represents frequency (Hz) and the Y-axis represents the sound pressure level (SPL) (dB).

Referring to the graph in FIG. 18, it may be identified that the frequency response of the speaker with the duct length L of 2.1 mm and 3 mm is closer to the target frequency response compared to the frequency response with a duct length L of 4.4 mm. That is, it may be identified that as the duct length L becomes shorter, the frequency response of the speaker is improved. Particularly, it may be identified that in the mid-to-low frequency range below 700 Hz, as the duct length L becomes shorter, the frequency response of the speaker is improved.

Referring to FIGS. 17 and 18, it may be identified that in order to control the rear sound leakage, a longer duct length (L) may be advantageous, whereas a shorter duct length (L) may be preferable for enhancing the acoustic performance of the speaker's, such as frequency response in the mid-to-low frequency range. Therefore, it may be identified that in order to improve the acoustic performance of the speaker while appropriately controlling the rear sound leakage, an appropriate design of the duct length L is required. For example, the duct length L may be smaller than or equal to 4 mm.

FIG. 19 is a graph depicting acoustic performance of a speaker according to a specific acoustic impedance of some components of a wearable electronic device according to an embodiment of the disclosure.

FIG. 19 illustrates a graph showing frequency response (frequency reaction) (FR) characteristics of the speaker (e.g., the speaker 330 in FIGS. 5 through 7, 9, and 10) and target frequency response characteristics of the speaker (e.g., the speaker 330 in FIGS. 5 through 7, 9, and 10) according to specific acoustic impedance (rayls) between the duct (e.g., the duct D in FIGS. 7 through 9, 12, and 13) and the second opening (e.g., the second opening 314 in FIGS. 5 through 10).

Specifically, in the graph in FIG. 19, the X-axis represents frequency (Hz) and the Y-axis represents the sound pressure level (SPL) (dB).

The specific acoustic impedance between the duct (e.g., the duct D in FIGS. 7 through 9, 12, and 13) and the second opening (e.g., the second opening 314 in FIGS. 5 through 10) may be determined by a combination of the size of the plate hole (e.g., the plate hole 371 in FIGS. 5 through 7 and 9 through 12) and the characteristics of the mesh member (e.g., the mesh member 362 in FIGS. 9 and 10).

Referring to FIG. 19, it may be identified that the frequency response characteristics of the speaker when the specific acoustic impedance between the duct (e.g., the duct D in FIG. 9) and the second opening (e.g., the second opening 314 in FIGS. 5 through 10) is 38 rayls, 46 rayls, and 56 rayls is closer to the target frequency response characteristics of the speaker, compared to the frequency response characteristics when the specific acoustic impedance of 83 rayls between the duct (e.g., the duct D in FIGS. 7 through 9, 12, and 13) and the second opening (e.g., the second opening 314 in FIGS. 5 through 10).

As such, in order to improve the acoustic performance of the speaker, it is necessary to configure appropriate specific acoustic impedance through design of the plate hole (e.g., the plate hole 371 in FIGS. 5 through 7 and 9 through 12) and the mesh member (e.g., the mesh member 362 in FIGS. 9 and 10). For example, the specific acoustic impedance may be about 30 rayls to about 60 rayls.

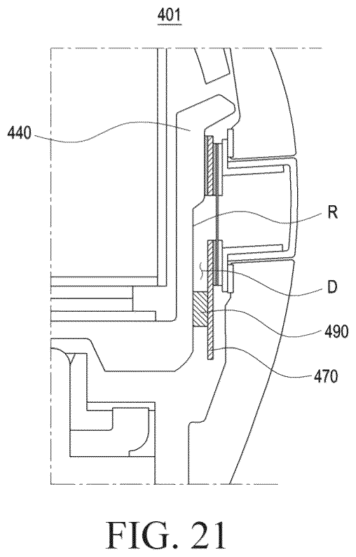

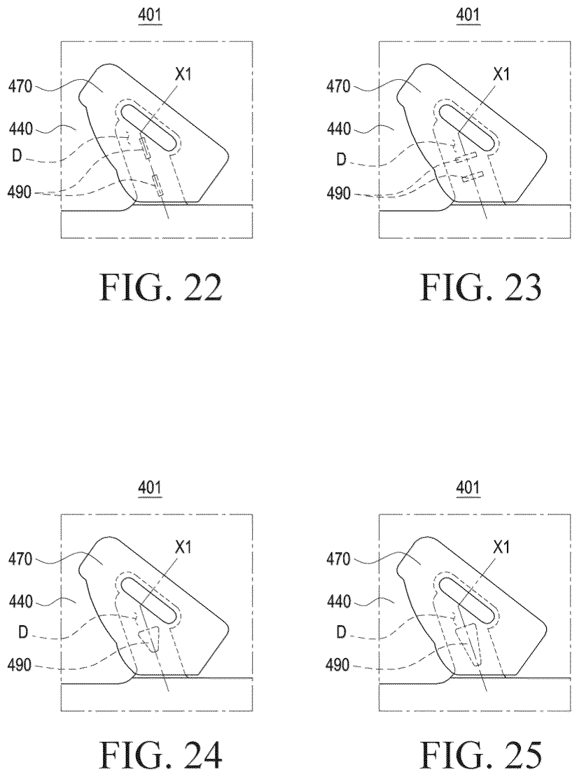

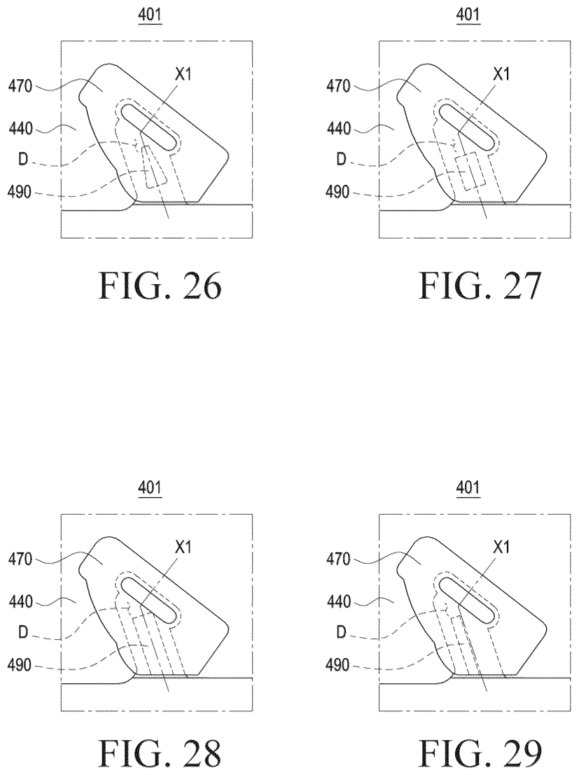

FIG. 20 is a planar view of some components of a wearable electronic device according to an embodiment of the disclosure. FIG. 21 is a cross-sectional view of some components of a wearable electronic device according to an embodiment of the disclosure. FIGS. 22 through 29 are views illustrating various examples of some components of a wearable electronic device according to an embodiment of the disclosure.

Specifically, FIG. 20 is a view illustrating the plate 470 viewed from the front so that the duct D is visible in a transparent manner. FIG. 21 is a cross-sectional view of FIG. 20 taken along line A-A′. FIGS. 22 through 29 illustrate various examples of a rib 490.

A detailed configuration of the wearable electronic device 401 according to an embodiment of the disclosure not described below may be identical to the detailed configuration of the wearable electronic device 301 according to an embodiment of the disclosure, related to FIGS. 1 through 18.

According to an embodiment, the bracket 440 may include the rib 490. The rib 490 may protrude from a bottom surface of the recess R. The rib 490 may come in contact with the plate 470. The rib 490 may correspond to a supporter configured to support the plate 470 with respect to the recess R. Through the rib 490, the plate 470 may be prevented from being distorted or damaged even if an external force is applied on the outside of the plate 470.

According to an embodiment, the rib 490 may extend in the extension direction X1 of the duct D. For example, as shown in FIG. 29, when viewed from the outer direction of the plate 470, the rib 490 may be configured to have a rectangular shape. For example, the rib 490 may be understood to have an elongated structure along the extension direction X1 of the duct D. Through the structure of the rib 490, in a process of sound flowing within the duct D, the influence of the ribs 490 may be minimized and an error in the non-acoustic impedance value of the duct D, configured by the design of the duct D may be minimized.

Unlike the description above, the ribs 490 may be of various shapes and numbers depending on the shape and/or size of the duct D. For example, as the size of the duct D increases, to effectively support the plate 470, the number of ribs 490 may be increased, the cross-sectional area of the ribs 490 may be enlarged, or the cross-sectional shape of the ribs 490 may be modified. In addition, the rib 490 may be provided to have various shapes to control the unique acoustic sound impedance of the duct D. For example, as the flow path cross-sectional area of the duct D is narrowed by the rib 490, the specific acoustic impedance of the duct D may increase.

For example, referring to FIG. 22, two ribs 490 may be provided, a cross-sectional view of each of the two ribs 490 may be a rectangular structure extending along the extension direction X1 of the duct D, and the two ribs 490 may be arranged along the extension direction X1 of the duct D. For example, referring to FIG. 23, two ribs 490 may be provided, a cross-sectional view of each of the two ribs 490 may be a rectangular structure extending along a direction intersecting the extension direction X1 of the duct D, and the two ribs 490 may be arranged along the extension direction X1 of the duct D. For example, referring to FIGS. 24 through 26, the cross-sectional shape of the rib 490 may be a polygonal structure. For example, the cross-section of the rib 490 may have an approximately triangular shape. For example, referring to FIG. 27, the cross-sectional shape of the rib 490 may be rectangular. For example, referring to FIGS. 28 and 29, the rib 490 may extend to an end portion of the duct D along the extension direction of the duct D.

The wearable electronic device may be worn on the user's ear. The wearable electronic device may be wiredly or wirelessly connected to an external electronic device (e.g., a mobile device) and convert an electrical signal transmitted from the external electronic device and output the electrical signal. Recently, wearable electronic devices including an adaptive noise cancellation (ANC) function have been introduced. These wearable electronic devices are generally of a kernel type including an ear tip. The kernel-type wearable electronic device has a structure sealing a user's ear. Conventionally, to alleviate the feeling of fullness when such kernel-type wearable electronic device is mounted on a user's ear, a structure has been introduced where the internal space of the user's ear and the external environment may communicate through an acoustic duct disposed inside a housing and an opening disposed on the housing. However, the wearable electronic device according to the conventional technology has the limitation to control the rear sound leakage occurring through the opening due to the absence of duct structure inside the housing. Furthermore, the narrow inner space of the housing caused limitations in securing the duct structure.

An aspect of the disclosure is to provide a wearable electronic device which may improve the acoustic performance while effectively controlling the rear sound leakage through a duct structure.

An aspect of the disclosure is to provide a wearable electronic device which may effectively realize a duct structure in a narrow space inside a housing of the wearable electronic device.

It should be understood that the problems to be solved by the disclosure are not limited to those mentioned above, and may be variously defined within a range that does not deviate from the spirit and scope of the disclosure.

The electronic device according to various embodiments of the disclosure may provide a duct structure inside a housing to effectively control a rear sound leakage and improve acoustic performance.

The electronic device according to various embodiments of the disclosure may effectively realize a duct structure in a narrow space inside a housing.

It will be appreciated by a person skilled in the art that effects which may be achieved from the disclosure are not limited to the effects described above and other effects that are not described above will be clearly understood from the following detailed description.

A wearable electronic device 301 or 401 according to an embodiment of the disclosure may include a housing 310 including a first opening 313 and a second opening 314.

The wearable electronic device 301 or 401 according to an embodiment of the disclosure may include a bracket 340 or 440 disposed in an inner space S of the housing 310 and including a side portion 342 facing the second opening 314.

The wearable electronic device 301 or 401 according to an embodiment of the disclosure may include a plate 370 or 470 disposed between the housing 310 and the side portion 342 of the bracket 340 or 440.

In the wearable electronic device 301 or 401 according to an embodiment of the disclosure, a recess R may be configured in the side portion 342, and the recess R may be recessed inward from an outer surface of the side portion 342 and extends toward the first opening 313 from an area overlapping the second opening 314.

In the wearable electronic device 301 or 401 according to an embodiment of the disclosure, the plate 370 or 470 may be seated on the side portion 342 to cover at least a portion of the recess R.

In the wearable electronic device 301 or 401 according to an embodiment of the disclosure, a duct D configured to communicate with the internal space S may be defined by the plate 370 or 470 and the recess R.

In the wearable electronic device 301 or 401 according to an embodiment of the disclosure, a plate hole 371 may be disposed on the plate 370 or 470 configured to allow the duct D to communicate with the second opening 314.

The wearable electronic device 301 or 401 according to an embodiment of the disclosure may further include a first adhesive member A1 disposed between the side portion 342 and the plate 370 or 470 and configured to attach the plate 370 or 470 to the side portion 342.

In the wearable electronic device 301 or 401 according to an embodiment of the disclosure, an adhesive opening AH having a shape corresponding to a shape of the recess R may be configured in the first adhesive member A1.

In the wearable electronic device 301 or 401 according to an embodiment of the disclosure, the duct D may be defined by the recess R, the plate 370 or 470, and the first adhesive member A1.

In the wearable electronic device 301 or 401 according to an embodiment of the disclosure, the first adhesive member A1 may be provided as at least one of double-sided tape, bond, glue, or adhesive.

In the wearable electronic device 301 or 401 according to an embodiment of the disclosure, a length between a point of the duct D, corresponding to a central part of the plate hole 371, and a first opening 313-side end portion of the duct (D) may be 4 mm or less.

The wearable electronic device 301 or 401 according to an embodiment of the disclosure may further include a mesh member 362 disposed outside the plate 370 or 470, and configured to cover the plate hole 371.

The wearable electronic device 301 or 401 according to an embodiment of the disclosure may further include a waterproof member disposed outside the plate 370 or 470.

The wearable electronic device 301 or 401 according to an embodiment of the disclosure may further include a compression member 380 disposed outside the plate 370 or 470.

In the wearable electronic device 301 or 401 according to an embodiment of the disclosure, the plate 370 or 470 may include at least one of steel use stainless (SUS), steel plate cold rolled commercial (SPCC), polycarbonate (PC), of polyethyleneterephthalate (PET).

In the wearable electronic device 301 or 401 according to an embodiment of the disclosure, the plate hole (371) may have a shape that extends in a direction intersecting an extension direction of the duct D.

In the wearable electronic device 301 or 401 according to an embodiment of the disclosure, the bracket 340 or 440 may include a seating portion 343 which is disposed on at least a portion of a periphery of the recess R and in close contact with the plate 370 or 470.

In the wearable electronic device 301 or 401 according to an embodiment of the disclosure, an outline of the seating portion 343 and an outline of the plate 370 or 470 may at least partially correspond to each other.

In the wearable electronic device 301 or 401 according to an embodiment of the disclosure, the bracket 340 or 440 may include a protrusion 344 protruding outward from at least a portion of an area corresponding to an edge of the plate 370 or 470.

In the wearable electronic device 301 or 401 according to an embodiment of the disclosure a side surface of the protrusion 344 and an outline of the plate 370 or 470 may at least partially correspond to each other.

In the wearable electronic device 401 according to an embodiment of the disclosure, the bracket 440 may include a rib 490 protruding from a bottom surface of the recess R and in contact with the plate 470.

In the wearable electronic device 401 according to an embodiment of the disclosure, the rib 490 may extend in the extension direction of the duct D.

A wearable electronic device 301 or 401 according to an embodiment of the disclosure may include a housing 310 including a first opening 313 and a second opening 314.

The wearable electronic device 301 or 401 according to an embodiment of the disclosure may include a battery 320 disposed in an inner space S of the housing 310.

The wearable electronic device 301 or 401 according to an embodiment of the disclosure may include a speaker 330 disposed in the inner space S and arranged at a side of the battery 320, facing the first opening 313.

The wearable electronic device 301 or 401 according to an embodiment of the disclosure may include a bracket 340 or 440 including a base portion 341 disposed between the battery 320 and the speaker 330 and a side portion 342 disposed between the battery 320 and the housing 310 and facing the second opening 314.

The wearable electronic device 301 or 401 according to an embodiment of the disclosure may include a plate 370 or 470 disposed between the housing 310 and the side portion 342 of the bracket 340 or 440.

In the wearable electronic device 301 or 401 according to an embodiment of the disclosure, a recess R may be configured in the side portion 342, and the recess R may be recessed inward from an outer surface of the side portion 342 and extends toward the first opening 313 from an area overlapping the second opening 314.

In the wearable electronic device 301 or 401 according to an embodiment of the disclosure, the plate 370 or 470 may be seated on the side portion 342 to cover at least a portion of the recess R.

In the wearable electronic device 301 or 401 according to an embodiment of the disclosure, a duct D configured to communicate with the internal space S may be defined by the plate 370 or 470 and the recess R.

In the wearable electronic device 301 or 401 according to an embodiment of the disclosure, a plate hole 371 may be disposed on the plate 370 or 470 configured to allow the duct D to communicate with the second opening 314.

The wearable electronic device 301 or 401 according to an embodiment of the disclosure may further include a first adhesive member A1 disposed between the side portion 342 and the plate 370 or 470 and configured to attach the plate 370 or 470 to the side portion 342.

In the wearable electronic device 301 or 401 according to an embodiment of the disclosure, an adhesive opening AH having a shape corresponding to a shape of the recess R may be configured in the first adhesive member A1.

In the wearable electronic device 301 or 401 according to an embodiment of the disclosure, the duct D may be defined by the recess R, the plate 370 or 470, and the first adhesive member A1.

The wearable electronic device 301 or 401 according to an embodiment of the disclosure may further include a mesh member 362 disposed outside the plate 370 or 470, and configured to cover the plate hole 371.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. A wearable electronic device comprising:
a housing comprising a first opening and a second opening;
a bracket disposed in an inner space of the housing and comprising a side portion facing the second opening; and
a plate disposed between the housing and the side portion of the bracket,
wherein the side portion of the bracket comprises a recess being recessed inward from an outer surface of the side portion and extending toward the first opening from an area overlapping the second opening,
wherein the plate is seated on the side portion and covers at least a portion of the recess,
wherein a duct is formed by the recess and is between the side portion of the bracket and the plate, and is configured to communicate with the inner space, and
wherein the plate comprises a plate hole configured to allow the duct to communicate with the second opening.

2. The wearable electronic device of claim 1, further comprising a first adhesive member between the side portion and the plate, and configured to attach the plate to the side portion.

3. The wearable electronic device of claim 2, wherein the first adhesive member comprises an adhesive opening having a shape corresponding to a shape of the recess.

4. The wearable electronic device of claim 2, wherein the duct is defined by the recess, the plate, and the first adhesive member.

5. The wearable electronic device of claim 2, wherein the first adhesive member is provided with at least one of double-sided tape, bond, glue or adhesive.

6. The wearable electronic device of claim 1, wherein a length between a point of the duct, corresponding to a central part of the plate hole, and a side end of the duct corresponding to the first opening is 4 mm or less.

7. The wearable electronic device of claim 1, further comprising a mesh member disposed outside the plate and configured to cover the plate hole.

8. The wearable electronic device of claim 1, further comprising a waterproof member disposed outside the plate and configured to cover the plate hole.

9. The wearable electronic device of claim 1, further comprising a compression member disposed outside the plate.

10. The wearable electronic device of claim 1, wherein the plate comprises at least one of steel use stainless (SUS), steel plate cold rolled commercial (SPCC), or polycarbonate (PC) of polyethyleneterephthalate (PET).

11. The wearable electronic device of claim 1, wherein the plate hole extends in a direction intersecting a direction in which the duct extends.

12. The wearable electronic device of claim 1, wherein the bracket further comprises a seating portion disposed on at least a portion of a periphery of the recess and contacts the plate, and
wherein a shape of an outline of the seating portion at least partially corresponds to a shape of an outline of the plate.

13. The wearable electronic device claim 12, wherein the bracket further comprises a protrusion protruding outward from at least a portion of an area, corresponding to an edge of the plate, of the seating portion, and
wherein a side surface of the protrusion at least partially corresponds to a shape of an outline of the plate.

14. The wearable electronic device of claim 1, wherein the bracket further comprises a rib protruding from a bottom of the recess and contacting the plate.

15. The wearable electronic device of claim 14, wherein the rib extends in a direction in which the duct extends.

16. A wearable electronic device comprising:
a housing comprising a first opening and a second opening;
a battery disposed in an inner space of the housing;
a speaker disposed in the inner space at a side of the battery and facing the first opening;
a bracket comprising:
a base portion disposed between the battery and the speaker; and
a side portion disposed between the battery and the housing and facing the second opening; and
a plate disposed between the housing and the side portion of the bracket,
wherein the side portion of the bracket comprises a recess being recessed inward from an outer surface of the side portion and extending toward the first opening from an area overlapping the second opening,
wherein the plate is seated on the side portion and covers at least a portion of the recess,
wherein a duct is formed by the recess and is between the side portion of the bracket and the plate, and is configured to communicate with the inner space, and
wherein the plate comprises a plate hole configured to allow the duct to communicate with the second opening.

17. The wearable electronic device of claim 16, further comprising a first adhesive member between the side portion and the plate, and configured to attach the plate to the side portion.

18. The wearable electronic device of claim 17, wherein the first adhesive member comprises an adhesive opening having a shape corresponding to a shape of the recess.

19. The wearable electronic device of claim 17, wherein the duct is defined by the recess, the plate, and the first adhesive member.

20. The wearable electronic device of claim 16, further comprising a mesh member disposed outside the plate and configured to cover the plate hole.
